(19) United States
(12) Patent Application Publication
(10) Pub. No.: US 2017/0067366 A1
(43) Pub. Date: Mar. 9, 2017

(54) DEVICE FOR BOUNDING A FLOW CHANNEL OF A TURBOMACHINE

(71) Applicant: MTU Aero Engines AG, Muenchen (DE)

(72) Inventor: Hans Stricker, Muenchen (DE)

(21) Appl. No.: 15/257,452

(22) Filed: Sep. 6, 2016

(30) Foreign Application Priority Data
Sep. 7, 2015 (DE) DE102015217078.0

(51) Int. Cl. F01D 25/14; F01D 11/00; F01D 25/24

(52) U.S. Cl. CPC F01D 25/145; F01D 25/24; F01D 11/005; F05D 2220/323; F05D 2260/52

(57) ABSTRACT

A device for bounding a flow channel of a turbomachine, comprising a wall that, viewed in the circumferential direction of the turbomachine, has a multiplicity of wall segments, and including a multiplicity of outer segments that extend radially around the outside of the wall segments; each wall segment having a uniformly curved first cross-sectional contour; each outer segment including at least one second cross sectional contour that deviates from the uniformly curved first cross-sectional contour; the second cross-sectional contour having a multiplicity of depressions that are inwardly directed in the radial direction of the gas turbine; at least a portion thereof being attached to the radially outer surface of a corresponding wall segment.

This claims the benefit of German Patent Application DE102015217078.8, filed Sep. 7, 2015 and hereby incorporated by reference herein.

The present invention relates to a device for bounding a flow channel of a turbomachine, for example, of a gas turbine.

### BACKGROUND

In turbomachines, such as gas turbines, an annular hot gas channel between two guide vane assemblies is frequently bounded radially outwardly by an annular wall. In the circumferential direction of the turbomachine, the wall can have a segmented design to allow thermally induced expansions of the outer wall during operation of the turbomachine. In addition, sealing elements, such as honeycomb seals, or abradable coatings can be provided on the radially inner side of the wall facing the hot gas channel. At the same time, the wall functions here as a seal carrier in order to minimize a radial gap between the rotor blades and the wall. Moreover, on the side of the wall facing away from the hot gas channel, a multiplicity of heat shields can be configured circumferentially adjacent to one another, to protect radially further outwardly disposed components of the turbomachine housing from temperatures in the hot gas channel.

By the middle regions thereof, the heat shields are generally disposed opposite the gaps between the seal carriers. During operation, it can occur that a portion of the hot gas flows into the gap between the seal carriers, thereby heating the end regions thereof. Moreover, the cooling air generally flows through gaps between the heat shields and impinges on the already cooler middle regions of the seal carrier. This results in high temperature gradients within the seal carrier that can lead to cracks.

The publication entitled “Design Modification to Enhance Fatigue Life of an Aero-Engine Heat Shield” describes how cracks are prevented from forming by modifying the heat shields. In this approach, stiffening elements are welded onto the heat shields. What is disadvantageous here is that the welded-on stiffening elements increase the weight of the configuration.

The publication EP 1 876 310 A2 describes structured metal sheets for use in vehicle components, in particular for heat shields. The structures are undulated in each of two directions of extension, so that a multiplicity of raised and recessed bosses having steep flanks are distributed over the entire surface. Two structured metal sheets are stacked one over the other, one metal sheet being supported on the flanks of the structure of the second metal sheet. This special support requires high manufacturing accuracy, thereby entailing increased component costs. Moreover, the two metal sheets are generally and, in particular in combination, susceptible to deformations induced by high temperatures. The two metal sheets can shift relative to each other, thereby degrading operational reliability.

The U.S. Patent Application 2003/0000675 A1 relates to a process for producing a spatially shaped layer from a hard and brittle material for use in gas turbines. Two such layers, which are joined together, form a honeycomb structure that is used to provide sealing action between turbine blades and a stator. Thus, the honeycomb structure is prone to wear and, therefore, is not suited for preventing cracks from forming in a component.

### SUMMARY OF THE INVENTION

It is an object of the present invention to provide a device for bounding a flow channel of a turbomachine, whose flow channel-side wall is rugged, but is thereby low in weight, is able to be manufactured with little outlay, and ensures a high level of operational reliability.

The approach provided is a device for bounding a flow channel of a turbomachine, such as a gas turbine, whose wall is subdivided in the circumferential direction of the gas turbine into a multiplicity of wall segments. In the circumferential direction of the gas turbine, the device also has a multiplicity of outer segments that extend radially around the outside of the wall segments. Each wall segment has a uniformly curved first cross-sectional contour in the circumferential direction. Each outer segment includes at least one second cross sectional contour that deviates from the uniformly curved first cross-sectional contour, the second cross-sectional contour having a multiplicity of depressions, which are inwardly directed in the radial direction of the gas turbine and of which as least a portion is attached to the outer surface of a corresponding wall segment. “A uniformly curved first cross-sectional contour” corresponds to an annular segment in the geometrical sense.

The advantage of the approach of the present invention is that the cross-sectionally contoured outer segments serve as a reinforcement for the wall segments, the bending resistance moment of the wall segments being increased. The outer segments, for example, heat shields enhance a stiffness of the wall segments, thereby countering a formation of cracks in the wall segments. At the same time, a uniform air mixing is achieved between the outer segments and the wall segments, thereby reducing the temperature gradients in the wall segments, likewise countering the formation of cracks. Therefore, the device has the feature of a rugged flow channel-side wall. The cross-sectional contour of the outer segments results in only minimal surfaces contacting the wall segments, whereby there is only minimal heat transfer from the wall segments to the outer segments. Thus, the outer segments integrate the functions of a heat shield and of a conventional reinforcing plate. This integration of functions makes it possible to save weight, thereby reducing manufacturing, as well as operating costs. Moreover, installation space within the turbomachine is saved. In other words, the wall of the flow channel is reinforced in order to prevent thermally induced cracks; in one preferred exemplary embodiment, heat shields being used to reinforce the wall. The heat shields have a dual functionality: on the one hand, namely, they protect radially outer gas turbine components from hot gas channel-side thermal radiation and, on the other hand, they structurally reinforce the wall of the hot gas channel.

In addition to the multiplicity of depressions, an advantageous embodiment of the present invention provides that the second cross-sectional contour include a multiplicity of elevations. The bending resistance moment of the outer segments is thereby further increased. Therefore, this further enhances the stability of the outer ring and thus of the composite assembly which is composed of one outer segment and one wall segment each.

One special embodiment of the present invention provides that the circumferential length of an outer segment equal that of a corresponding wall segment, and that, in each case, an outer gap between two outer segments and an inner gap between two wall segments radially oppose one another. Thus, cooling air, that is inwardly directed through the outer gaps, is able to cool counter-flowing hot gas that is forced outwardly through the inner gaps, immediately upon emergence thereof from the turbine chamber.

In addition, a sealing element, which covers a corresponding outer gap, may be mounted on each outer segment. The purpose of covering the outer gap is to reduce the leakage of hot gas.

One alternative embodiment of the present invention provides that the circumferential length of an outer segment equal that of a corresponding wall segment, and that the outer segments be offset relative to the wall segments in the circumferential direction of the gas turbine. The cooling air flows and hot gas flows do not encounter each other directly. Rather, they stream in the circumferential direction of the gas turbine, offset from each other, into the intermediate space between each outer segment and wall segment. This allows the cooling air to be directed with minimal losses onto the hot gas being forced out of the turbine chamber, in order to cool the same.

Moreover, a spring element, for bracing against a housing section of the turbomachine, may be mounted on each outer segment. A radially inwardly directed spring force hereby acts on the wall segments and keeps the wall segments in the setpoint position thereof independently of the operating state, flying maneuvers and the like. The spring element may also function as a sealing lip. The spring elements preferably likewise have a second cross-sectional contour. For example, the spring elements are sinusoidal in cross section in the circumferential direction of the gas turbine and are provided with depressions and/or elevations.

In a special further embodiment of the present invention, at least one cover element is attached to the outer segment in the circumferential direction of the turbomachine; in particular, the cover element being attached to elevations of the second cross-sectional structure of the outer segment. The result is a sandwich structure. The stability of the assembly, which is composed of one outer segment and one wall segment each, is further enhanced by the cover element.

In addition, the cover element may have a uniformly curved first cross-sectional contour. A uniformly curved first cross-sectional contour is readily manufactured and may be easily attached to an outer segment.

Moreover, a jet engine may include the device.

Alternatively, a stationary gas turbine may include the device.

### BRIEF DESCRIPTION OF THE DRAWINGS

Four exemplary embodiments of the present invention are described in greater detail in the following with reference to the four figures, in which:

FIG. 1 shows an axial sectional view of a device according to the present invention in accordance with a first exemplary embodiment;

FIG. 2 shows an axial sectional view of a device according to the present invention in accordance with a second exemplary embodiment;

FIG. 3 shows an axial sectional view of the device according to the present invention in accordance with a third exemplary embodiment;

FIG. 4 shows wall segments and outer segments in a sectional view in the circumferential direction in accordance with a fourth exemplary embodiment of the device according to the present invention; and

FIG. 5 shows wall segments and outer segments in a sectional view in the circumferential direction in accordance with a fifth exemplary embodiment of the device according to the present invention.

### DETAILED DESCRIPTION

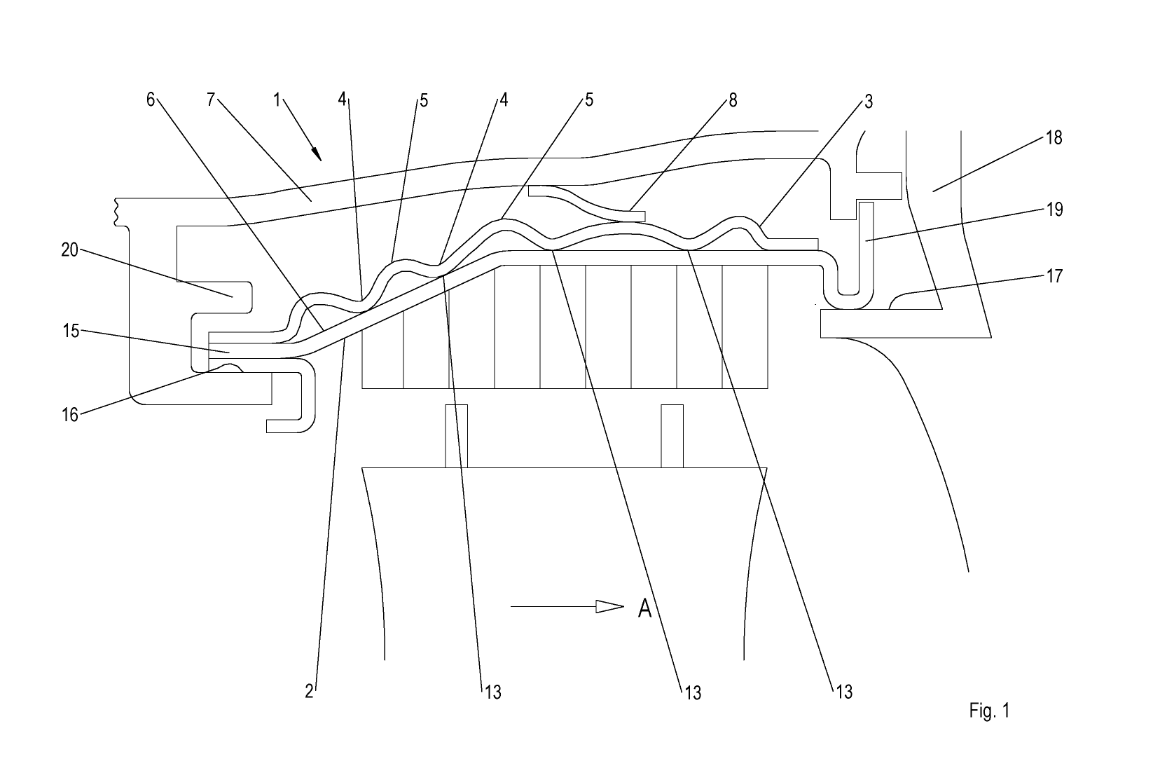

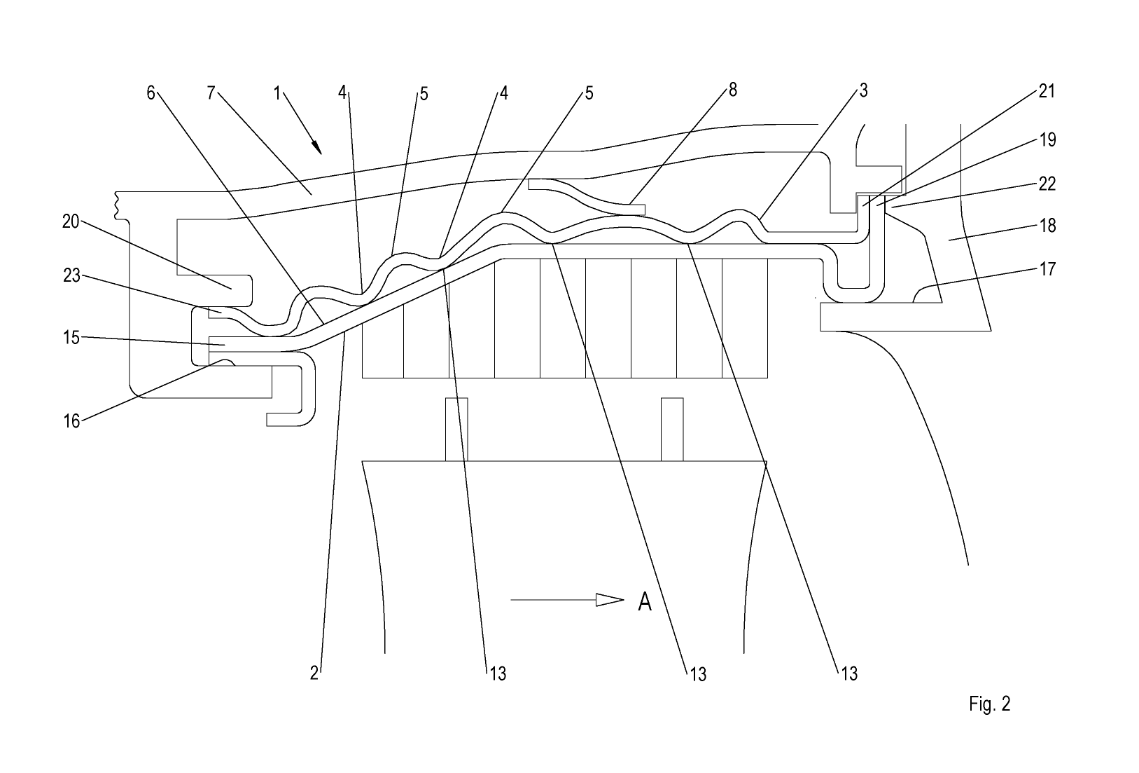

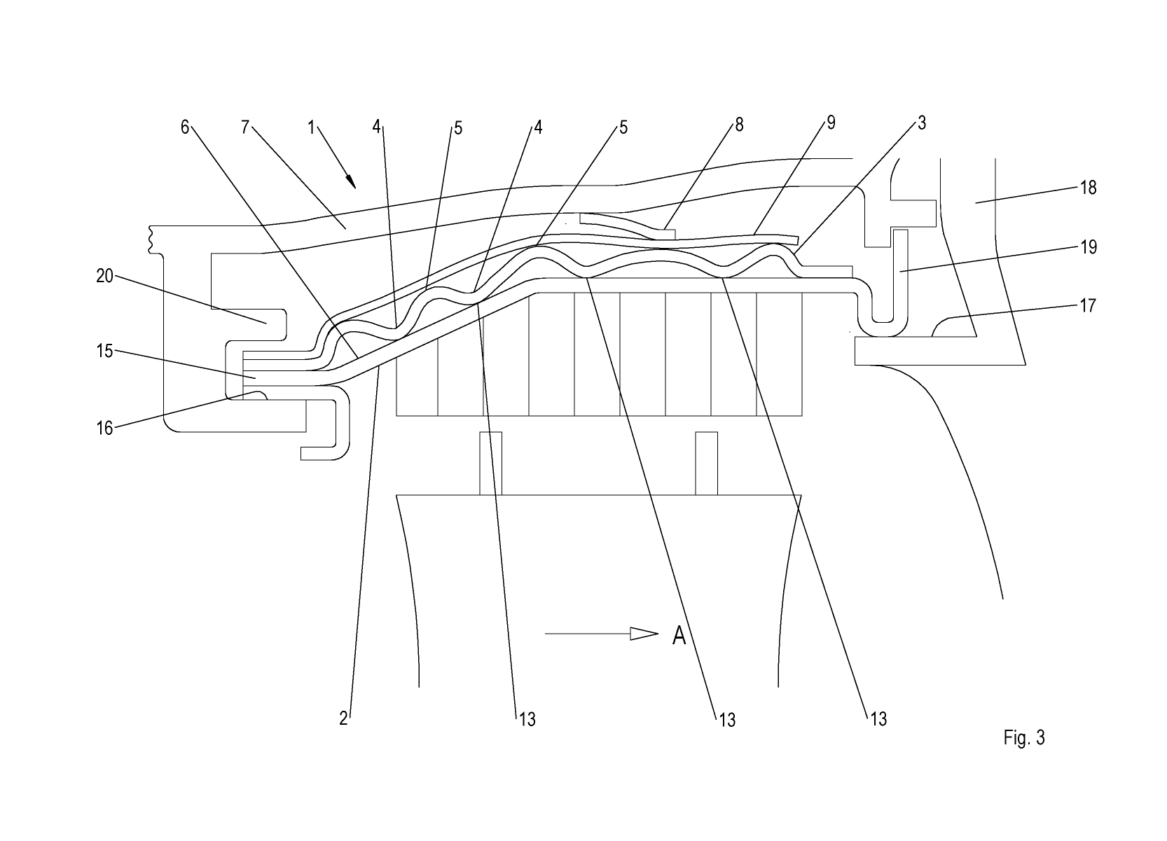

FIGS. 1, 2 and 3 show a device 1 according to the present invention for an otherwise merely schematically indicated gas turbine; FIG. 1 illustrating a first specific embodiment, FIG. 2 a second specific embodiment, and FIG. 3 a third specific embodiment. Device 1 includes wall segments 2 that are configured in a circumferential direction U, and outer segments 3 that are likewise configured in circumferential direction U and are each attached to radially outer surface 6 of a corresponding wall segment 2.

In the exemplary embodiments shown here, wall segments 2 form a wall, respectively annular wall, that bounds a hot gas channel of the turbomachine radially outwardly. Here, outer segments 3 are heat shields for protecting radially outer housing sections 7 and other components of the turbomachine from temperatures in the hot gas channel. The heat shields have a dual functionality: on the one hand, namely, they protect radially outer gas turbine components from hot gas channel-side thermal radiation and, on the other hand, they structurally reinforce the wall of the hot gas channel.

Each wall segment 2 has a uniformly curved first cross-sectional contour in circumferential direction U. The shape of the first cross-sectional contour corresponds to an annular segment in the geometrical sense. By one portion 15, which, viewed in the direction of flow, is leading, wall segments 2 engage in each case on a peripherally disposed, radially outer housing surface 16 of a leading receiving recess. A trailing portion of wall segments 2 engages on a peripherally disposed, radially inner housing surface 17 of a trailing receiving recess of a housing section 18 adjacent to housing section 7. In addition, each wall segment 2 has a trailing, radially outwardly extending end portion 19, by which it engages on housing section 7, partially overlapping therewith.

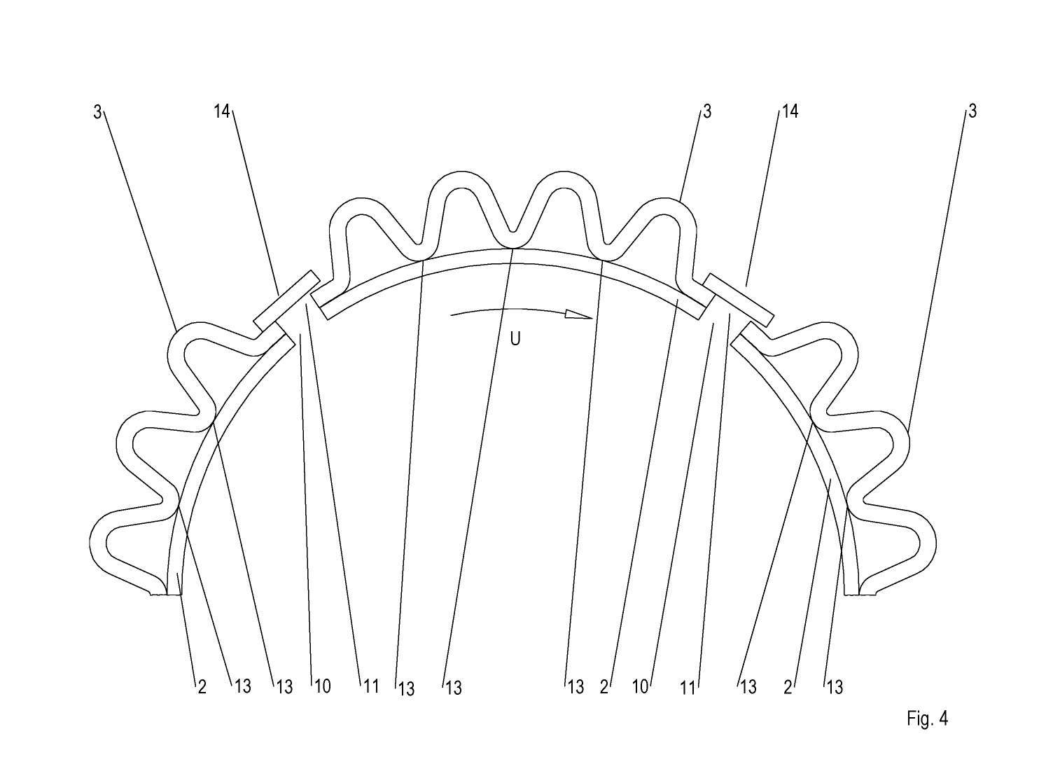

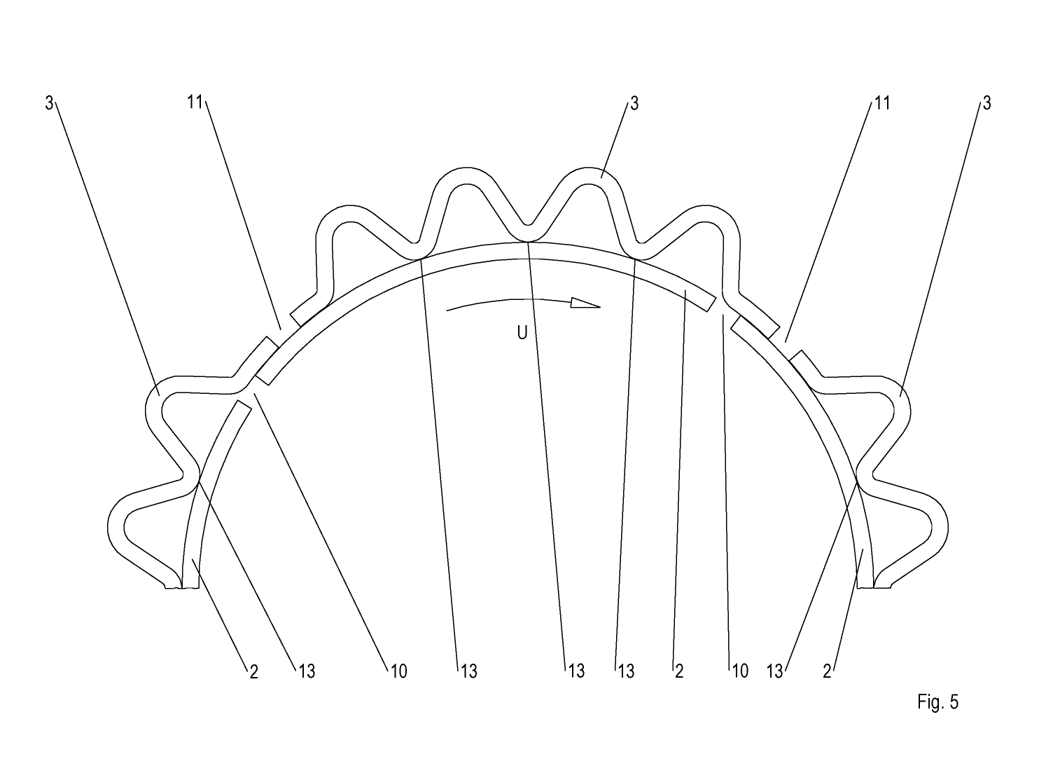

Each outer segment 3 is designed as a molded part and has depressions 4 and elevations 5. In particular, in cross section, each outer segment 3 is essentially sinusoidal in an axial direction A of the gas turbine. In cross section, each outer segment 3 is likewise essentially sinusoidal in circumferential direction U of the gas turbine (see also FIGS. 4 and 5). The sinusoidal design variant is an example of a second cross-sectional contour. The basic form of outer segment 3 is made up of an imaginary envelope of an outer segment 3, including depressions 4 and/or elevations 5. However, any other desired geometric shapes may also be selected for depressions 4 and elevations 5. Moreover, each outer segment 3 may be configured as a thin metal sheet.

Depressions 4 of outer segment 3 and outer surface 6 of corresponding wall segment 2 form points of contact 13 that make an attachment possible. Depressions 4 and outer surface 6 of wall segment 2 are welded to one another or soldered together at points of contact 13. Points of contact 13 should be as small as possible to minimize the heat conduction from wall segment 2 to outer segment 3. Thus, due to the permanent connections at points of contact 13, outer segment 3 reinforces corresponding wall segment 2. Consequently, wall segments 2 are equal in number to outer segments 3 (see also FIGS. 3 and 4). However, there is no need for all depressions 4 to be permanently connected to radially outer surface 6 of wall segments 2. The number of fixed points of contact 13 is variable. However, a sufficient reinforcement of wall segments 2 is to be ensured.

The intermediate spaces between elevations 5 of the outer segments and of outer surface 6 of wall segments 2 allow cooling air to flow therethrough.

Associated here with each outer segment 3 is a spring element 8 that may be configured as a thin metal sheet. Each spring element 8 is permanently joined to a corresponding outer segment 3.

Each spring element 8 is adapted to the geometric shape of corresponding outer segment 3; i.e., each spring element 8 likewise features the second cross-sectional contour. Thus, in this specific exemplary embodiment, it is likewise sinusoidal in cross section, in circumferential direction U of the gas turbine, and provided with depressions and/or elevations (not shown). In FIGS. 1, 2 and 3, spring element 8 is shown in the unloaded state; however, during operation, it presses corresponding outer segment 3 toward corresponding wall segment 2. This is also aided by the high pressure that bears externally against outer segment 3.

In accordance with FIG. 2, in the second specific embodiment, device 1 differs from the first specific embodiment in accordance with FIG. 1, on the one hand, in that, viewed in the direction of flow, outer segments 3 have a leading spring portion 23 that is braced against a radially outer housing projection 20 of the leading receiving recess, and thereby act with a radially inwardly directed force on wall segments 2 in the leading region thereof.

On the other hand, in the second specific embodiment according to FIG. 2, device 1 differs from the first specific embodiment in accordance with FIG. 1 in that, viewed in the direction of flow, outer segments 3 each have a trailing hook portion 21, which, together with the radially outwardly directed end portion 19 of wall segment 2, is clamped in between housing section 7 and an axial projection 22 of adjacent housing section 18.

In accordance with FIG. 3, device 1 in the third specific embodiment differs from the first specific embodiment in accordance with FIG. 1 in that a cover element 9 is mounted on the outer periphery of each outer segment 3. Cover element 9 may be configured as a sheet metal plate and provides an even greater reinforcement for a corresponding wall segment 2 than does solely attaching a corresponding outer segment 3. Cover element 9 is attached to elevations 5 of corresponding outer segment 3, for example, by welding or soldering. Spring element 8 is attached to cover element 9.

In FIGS. 4 and 5, wall segments 2 and outer segments 3 are shown in sectional views in circumferential direction U. An inner gap 10 is located in each case between two adjacent wall segments 2. An outer gap 11 is located in each case between two adjacent outer segments 3. Here, outer segments 3 have the same circumferential length as wall segments 2.

In FIG. 4, an inner gap 10 and an outer gap 11 oppose one another, respectively. An inner gap 10 and an outer gap 11 are each overlapped by a sealing element 14 (referred to as a shiplap). Each sealing element 14 is attached to an outer segment 3 and extends over a portion of an adjacent outer segment 3.

In FIG. 5, inner gaps 10 and outer gaps 11 are mutually offset, i.e., an outer segment 3 projects over an inner gap 10 in each case. Therefore, in contrast to the example in FIG. 4, no separate sealing elements are required. Thus, the sinusoidal shape of each outer segment 3 extends in circumferential direction U beyond a corresponding inner gap 10. It should be noted that a “profiled” overlapping is also generally possible. This means that outer segments 3 extend in circumferential direction U beyond a corresponding inner gap 10 and have a side portion that corresponds to the cross-sectional contour of the respective adjacent outer segment 3 in the overlap region.

The first specific embodiment in accordance with FIG. 1, the second specific embodiment in accordance with FIG. 2, and the third specific embodiment in accordance with FIG. 3 may each feature, in circumferential direction U, the fourth specific embodiment in accordance with FIG. 4, and the fifth specific embodiment in accordance with FIG. 5, as well as the specific embodiment (not shown) of the “profiled overlapping” mentioned in the previous paragraph.

An outer segment 3 may be manufactured by passing a plane metal sheet through a number of roller pairs for cold working of metal sheets, initially forming a metal sheet having a uniformly curved cross-sectional contour. The last roller pair has a shape that complements depressions 4 and elevations 5 of outer segment 3 and thereby forms depressions 4 and elevations 5 in outer segment 3.

The present invention relates to a device for bounding a flow channel of a turbomachine, having a wall that, viewed in the circumferential direction of the turbomachine, features a multiplicity of wall segments, and having a multiplicity of outer segments that extend radially around the outside of the wall segments; each wall segment having a uniformly curved first cross-sectional contour; each outer segment including at least one second cross sectional contour that deviates from the uniformly curved first cross-sectional contour; the second cross-sectional contour having a multiplicity of depressions that are inwardly directed in the radial direction of the gas turbine; at least a portion thereof being attached to the radially outer surface of a corresponding wall segment.

### LIST OF REFERENCE NUMERALS

1 device
2 wall segment
3 outer segment
4 depression
5 elevation
6 outer surface
7 housing section
8 spring element
9 cover element
10 inner gap
11 outer gap
13 point of contact
14 sealing element
15 leading portion
16 leading housing surface
17 trailing housing surface
18 housing section
19 end portion
20 housing projection
21 hook portion
22 axial projection
23 spring portion
U circumferential direction
A axial direction

What is claimed is:

1. A device for bounding a flow channel of a turbomachine, comprising:
a wall, the wall, viewed in a circumferential direction of the turbomachine, having a multiplicity of wall segments, and
a multiplicity of outer segments extending radially around an outside of the wall segments;
each wall segment having a uniformly curved first cross-sectional contour, and each outer segment including at least one second cross sectional contour deviating from the uniformly curved first cross-sectional contour; the second cross-sectional contour having a multiplicity of depressions inwardly directed in a radial direction of the gas turbine;
at least a portion of the depressions being attached to a radially outer surface of a corresponding wall segment.

2. The device as recited in claim 1 wherein, in addition to the multiplicity of depressions, the second cross-sectional contour including a multiplicity of elevations.

3. The device as recited in claim 1 wherein a circumferential length of an outer segment equals that of a corresponding wall segment and, in each case, an outer gap between two outer segments and an inner gap between two wall segments radially oppose one another.

4. The device as recited in claim 3 wherein a seal covers a corresponding outer gap and is mounted on each outer segment.

5. The device as recited in claim 1 wherein a circumferential length of an outer segment equals that of a corresponding wall segment, and the outer segments are offset relative to the wall segments in the circumferential direction of the gas turbine.

6. The device as recited in claim 1 further comprising a spring for bracing against a housing section of the turbomachine, the spring mounted on each outer segment.

7. The device as recited in claim 1 further comprising at least one cover element attached to the outer segment in the circumferential direction of the turbomachine.

8. The device as recited in claim 7 wherein the cover element is attached to elevations of the second cross-sectional structure of the outer segment.

9. The device as recited in claim 7 wherein the cover element has a uniformly curved cross-sectional contour.

10. A jet engine comprising the device as recited in claim 1.

11. A stationary gas turbine comprising the device as recited in claim 1.
